(19) United States
(12) Patent Application Publication
(10) Pub. No.: US 2024/0142706 A1
(43) Pub. Date: May 2, 2024

(54) MULTIPLE FILTER COMPONENT CONFIGURATION FOR WAVELENGTH DIVISION MULTIPLEXING DEVICE

(71) Applicant: Lumentum Operations LLC, San Jose, CA (US)

(72) Inventors: Jinqiang YU, Shenzhen, Guangdong (CN); Bin TAN, Shenzhen (CN)

(21) Appl. No.: 17/755,369

(22) PCT Filed: Mar. 31, 2022
(86) PCT No.: PCT/CN2022/084475

§ 371 Date: Apr. 27, 2022

(30) Foreign Application Priority Data
Dec. 8, 2021 (WO) PCTCN2021136378

(51) Int. Cl. G02B 6/293

(52) U.S. Cl. CPC G02B 6/2937; G02B 6/29367

(57) ABSTRACT

In some implementations, a wavelength division multiplexing (WDM) device includes a spacer; a first filter component; and a second filter component. The spacer is configured to propagate a light beam emitted from an input fiber of the WDM device within the spacer to the first filter component. The first filter component is configured to filter the light beam to create and direct a once-filtered light beam to the spacer. The spacer is configured to propagate the once-filtered light beam within the spacer to the second filter component. The second filter component is configured to filter the once-filtered light beam to create and direct a twice-filtered light beam to the spacer. The spacer is configured to propagate the twice-filtered light beam within the spacer to another component of the WDM device, such as another filter component, a mirror component, or an output fiber of the WDM device.

### CROSS-REFERENCE TO RELATED APPLICATION

This Patent application claims priority to Patent Cooperation Treaty (PCT) Patent Application No. PCT/CN2021/136378, filed on Dec. 8, 2021, and entitled “MULTIPLE FILTER PACKAGE CONFIGURATION FOR WAVELENGTH DIVISION MULTIPLEXER” The disclosure of the prior Application is considered part of and is incorporated by reference into this Patent Application.

### TECHNICAL FIELD

The present disclosure relates generally to a wavelength division multiplexing (WDM) device, and to a multiple filter component configuration for the WDM device.

### BACKGROUND

WDM is a technology used in optical communications to transmit a plurality of optical carrier signals over a single optical fiber. Each optical carrier signal is associated with a particular wavelength and therefore the plurality of optical carrier signals can be transmitted over the single optical fiber at the same time.

### SUMMARY

In some implementations, a WDM device includes a housing; an input fiber; an output fiber; a first lens; a second lens; a spacer; a first filter component; and a second filter component, wherein: the input fiber is configured to emit a light beam to the first lens; the first lens is configured to direct the light beam to the spacer; the spacer is configured to propagate the light beam within the spacer to the first filter component; the first filter component is configured to pass one or more portions of the light beam to the spacer and to block one or more other portions of the light beam; the spacer is configured to propagate the one or more portions of the light beam to the second filter component; the second filter component is configured to pass one or more subportions of the one or more portions of the light beam to the spacer and to block one or more other subportions of the one or more portions of the light beam; and the spacer is configured to propagate at least some of the one or more subportions of the one or more portions of the light beam to the output fiber.

In some implementations, a WDM device includes a spacer; a first filter component; and a second filter component, wherein: the spacer is configured to propagate a light beam emitted from an input fiber of the WDM device within the spacer to the first filter component; the first filter component is configured to filter the light beam to create and direct a once-filtered light beam to the spacer; the spacer is configured to propagate the once-filtered light beam within the spacer to the second filter component; the second filter component is configured to filter the once-filtered light beam to create and direct a twice-filtered light beam to the spacer; and the spacer is configured to propagate the twice-filtered light beam within the spacer to another component of the WDM device.

In some implementations, a WDM device includes a cylindrical housing; and a plurality of filter components disposed within an internal portion of the cylindrical housing, wherein: a first filter component, of the plurality of filter components, is configured to filter a light beam emitted from an input fiber of the WDM device to create and direct a once-filtered light beam to a second filter component of the plurality of filter components; and the second filter component is configured to receive and filter the once-filtered light beam to create and direct a twice-filtered light beam to another component of the WDM device.

### BRIEF DESCRIPTION OF THE DRAWINGS

FIGS. 1A-1B are diagram of an example optical device described herein.

FIGS. 2A-2B are diagrams of another example optical device described herein.

FIG. 3 is a diagram of an example optical performance of an optical device described herein.

### DETAILED DESCRIPTION

The following detailed description of example implementations refers to the accompanying drawings. The same reference numbers in different drawings may identify the same or similar elements.

Erbium-doped fiber amplifiers (EDFAs) are an important enabling technology for optical communication. In some cases, an EDFA uses a two-port wavelength division multiplexer (WDM), which passes one wide wavelength band (a “pass band”) and blocks another, adjacent wide wavelength band (a “block band”). However, when a wavelength range gap between the pass band and the block band is small, a single filter cannot be used in the WDM (e.g., a single filter cannot pass all of the pass band and block all of the block band). A wavelength range gap is small when, for example, the wavelength range gap is less than 3% of a width of the pass band. For example, for a 17.5 nanometer (nm) width passband filter (e.g., that passes light associated with a 1500-1517.5 nm wavelength range), a wavelength range gap is small when it is less than 0.5 nm (e.g., less than 3% of the width of the passband filter). Accordingly, a single-filter WDM device cannot provide an optimal optical performance for small wavelength range gap applications.

Some implementations described herein provide an optical device (e.g., a WDM device) that may include a plurality of filter components (e.g., in a cascading formation) that may be arranged with other optical components, such as a first lens, a second lens, a spacer, and/or other optical components. The plurality of filter components may be configured to provide a particular optical performance (e.g., to satisfy a particular optical performance requirement). For example, the plurality of filter components may be configured to propagate one or more portions of a light beam to an output fiber of the optical device and to prevent one or more other portions of the light beam from propagating to the output fiber. The one or more portions of the light beam may be associated with a set of one or more wavelength ranges of light, and the one or more other portions of the light beam may be associated with another set of one or more wavelength ranges of light. A wavelength range gap between the set of one or more wavelength ranges of light and the other set of one or more wavelength ranges of light may satisfy (e.g., be less than or equal to) a wavelength range gap threshold, such as 0.5 nanometers.

In this way, by utilizing the plurality of filter components, the optical device provides an optical performance that cannot be achieved using a single-filter WDM. Further, the plurality of filter components may be arranged within an internal portion of a housing (e.g., a cylindrical housing) of the optical device. This enables the optical device to be used in practical applications (e.g., practical optical amplification applications), as opposed to other configurations of filter components that require a larger footprint. Accordingly, because the optical device has a reduced size and an increased robustness, the optical device is able to be used in some applications (e.g., optical amplification applications) in which a device with a larger footprint is not able to be used.

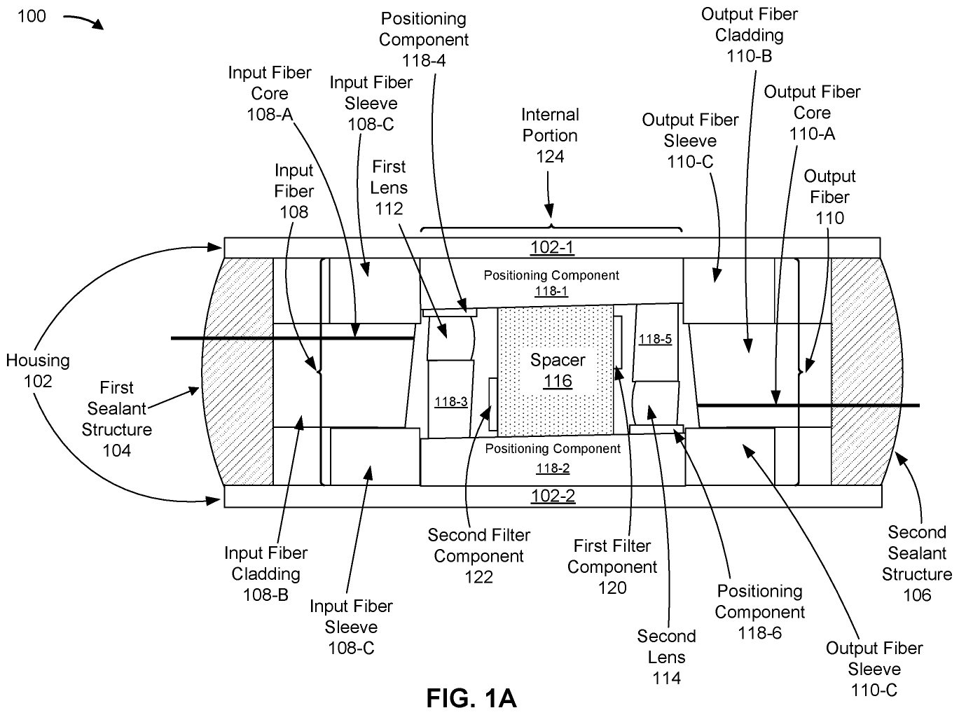

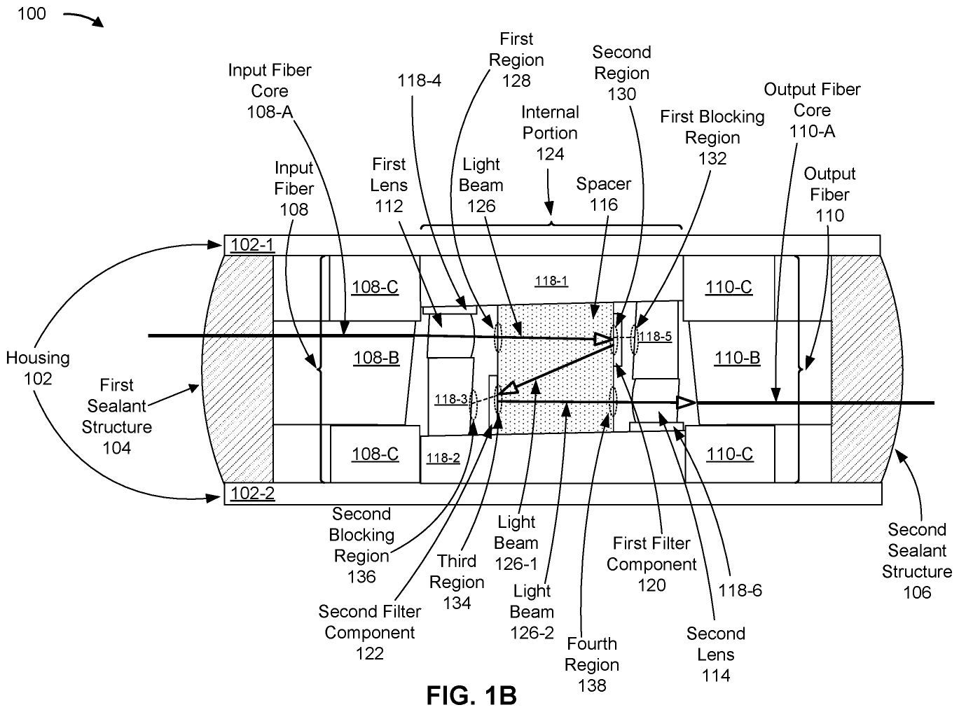

FIGS. 1A-1B are diagrams of an example optical device 100 described herein, such as a wavelength division multiplexing (WDM) device. As shown in FIGS. 1A-1B, the optical device 100 may include a housing 102 (e.g., shown as comprising a top housing portion 102-1 and a bottom housing portion 102-2), a first sealant structure 104, a second sealant structure 106, an input fiber 108, an output fiber 110, a first lens 112, a second lens 114, a spacer 116, one or more positioning components 118 (e.g., shown as comprising one or more positioning components 118-1 through 118-6), a first filter component 120, and/or a second filter component 122.

The optical device 100 may have a cylindrical shape. For example, the housing 102, the first sealant structure 104, the second sealant structure 106, the input fiber 108, the output fiber 110, and/or one or more other components of the optical device 100 may be cylindrical.

The housing 102 may be configured to contain and/or to protect one or more other elements of the optical device 100 (e.g., from an environment external to the housing 102 and/or the optical device 100). Accordingly, the one or more other elements of the optical device 100 may be positioned within the housing 102 (e.g., as further described herein). The housing 102 may comprise, for example, metal, glass, or a similar material.

The housing 102 may include one or two ends. For example, as shown in FIGS. 1A-1B, when the housing 102 is a cylindrical housing, the housing 102 may include a first end (e.g., the left end of the housing 102) and a second end (e.g., the right end of the housing 102). The first sealant structure 104 and the second sealant structure 106 may each be configured to seal an end of the housing 102. For example, as further shown in FIGS. 1A-1B, the first sealant structure 104 may be configured to seal the first end of the housing 102, and the second sealant structure 106 may be configured to seal the second end of the housing 102. In this way, the first sealant structure 104 and the second sealant structure 106 may prevent moisture, dust, debris, or other material from entering within the housing 102, and thereby protect one or more other components of the optical device 100 from being damaged. Each of the first sealant structure 104 and the second sealant structure may comprise, for example, a silicon epoxy or a similar material.

The input fiber 108 may be positioned at the first end (e.g., the left end) of the housing 102. The input fiber 108 may be configured to provide a light beam (e.g., light beam 126, as shown in FIG. 1B) to the optical device 100 (e.g., via the first end of the optical device 100). The light beam may be associated with a plurality of wavelength ranges (e.g., the light beam may include different wavelength ranges of light) and may originate from another optical device (e.g., a light source, not shown in FIGS. 1A-1B). In some implementations, as shown in FIGS. 1A-1B, the first sealant structure 104 may be configured to affix and/or seal the input fiber 108 at the first end of the housing 102 (e.g., the first sealant structure 104 may be formed circumferentially around a portion of the input fiber 108 at the first end of the housing 102).

The input fiber 108 may comprise one or more input fiber components, such as an input fiber core 108-A, an input fiber cladding 108-B, and/or an input fiber sleeve 108-C. The input fiber core 108-A may be configured to propagate the light beam (e.g., from the other optical device to an internal portion 124 of the housing 102). Accordingly, as shown in FIGS. 1A-1B, the input fiber core 108-A may extend through the first sealant structure 104 to an external environment (e.g., in order to receive the light beam from the other optical device). The input fiber core 108-A may comprise glass, plastic, and/or a similar material. The input fiber core 108-A may have a particular diameter size, such as 250 micrometers (μm), 900 μm, or another diameter size. The input fiber core 108-A may include an exit surface, through which the light beam may emit from the input fiber core 108-A (e.g., as further described herein). In some implementations, the exit surface may be angled (e.g., the exit surface may be arranged at a non-zero angle to a normal of a propagation axis of the light beam through the input fiber core 108-A), such as to facilitate emission of the light beam from the exit surface. The exit surface may be coated with an optical coating, such as an antireflective (AR) coating (e.g., to further facilitate emission of the light beam from the exit surface).

The input fiber cladding 108-B may be configured to protect the input fiber core 108-A and/or to prevent, or to minimize, leakage of the light beam from the input fiber core 108-A (e.g., as the light propagates through the input fiber core 108-A). The input fiber cladding 108-B may circumferentially (e.g., completely circumferentially or partially circumferentially) surround the input fiber core 108-A. The input fiber cladding 108-B may comprise glass, plastic, and/or a similar material. The input fiber sleeve 108-C may be configured to protect the input fiber core 108-A and/or the input fiber cladding 108-B. The input fiber sleeve 108-C may circumferentially (e.g., completely circumferentially or partially circumferentially) surround the input fiber cladding 108-B. The input fiber sleeve 108-C may comprise glass, plastic, ceramic, metal, and/or a similar material.

In some implementations, the input fiber core 108-A may be offset from a central point of the input fiber cladding 108-B and/or the input fiber sleeve 108-C. For example, as shown in FIGS. 1A-1B, the input fiber core 108-A may be arranged in a “high” position (e.g., that is closer to the top housing portion 102-1 of the housing 102 than the bottom housing portion 102-2 of the housing 102). Accordingly, when the light beam emits from the input fiber core 108-A, the light beam has space to propagate within the internal portion 124 of the housing 102 (e.g., via one or more other elements of the optical device 100) to the output fiber 110, as further described herein.

The output fiber 110 may be positioned at a second end (e.g., the right end, in FIGS. 1A-1B) of the housing 102. The output fiber 110 may be configured to propagate a light beam (e.g., light beam 126, as shown in FIG. 1B) away from the optical device 100 (e.g., via the second end of the optical device 100), such as to another optical device (e.g., a light beam destination, not shown in FIGS. 1A-1B). The light beam may be associated with a plurality of wavelength ranges (e.g., the light beam may include different wavelength ranges of light) and may be received by the output fiber 110 after the light beam is emitted by the input fiber 108, and propagates through the internal portion 124 of the housing 102, as described herein. In some implementations, as shown in FIGS. 1A-1B, the second sealant structure 106 may be configured to affix and/or seal the output fiber 110 at the second end of the housing 102 (e.g., the second sealant structure 106 may be formed circumferentially around a portion of the output fiber 110 at the second end of the housing 102).

The output fiber 110 may comprise one or more output fiber components, such as an output fiber core 110-A, an output fiber cladding 110-B, and/or an output fiber sleeve 110-C. The output fiber core 110-A may be configured to receive the light beam (e.g., after the light beam propagates within the internal portion 124 of the housing 102) and to propagate the light beam (e.g., to the light beam destination). Accordingly, as shown in FIGS. 1A-1B, the output fiber core 110-A may extend through the second sealant structure 106 to an external environment (e.g., in order to propagate the light beam to the light beam destination). The output fiber core 110-A may comprise glass, plastic, and/or a similar material. The output fiber core 110-A may have a particular diameter size, such as 250 μm, 900 μm, or another diameter size. The output fiber core 110-A may include an entrance surface, through which the light beam may enter the output fiber core 110-A (e.g., as further described herein). In some implementations, the entrance surface may be angled (e.g., the entrance surface may be arranged at a non-zero angle to a normal of a propagation axis of the light beam through the output fiber core 110-A), such as to facilitate reception of the light beam via the entrance surface. The entrance surface may be coated with an optical coating, such as an antireflective (AR) coating (e.g., to further facilitate reception of the light beam via the entrance surface).

The output fiber cladding 110-B may be configured to protect the output fiber core 110-A and/or to prevent, or to minimize, leakage of the light beam from the output fiber core 110-A (e.g., as the light propagates through the output fiber core 110-A). The output fiber cladding 110-B may circumferentially (e.g., completely circumferentially or partially circumferentially) surround the output fiber core 110-A. The output fiber cladding 110-B may comprise glass, plastic, and/or a similar material. The output fiber sleeve 110-C may be configured to protect the output fiber core 110-A and/or the output fiber cladding 110-B. The output fiber sleeve 110-C may circumferentially (e.g., completely circumferentially or partially circumferentially) surround the output fiber cladding 110-B. The output fiber sleeve 110-C may comprise glass, plastic, ceramic, metal, and/or a similar material.

In some implementations, the output fiber core 110-A may be offset from a central point of the output fiber cladding 110-B and/or the output fiber sleeve 110-C. For example, as shown in FIGS. 1A-1B, the output fiber core 110-A may be arranged in a “low” position (e.g., that is closer to the bottom housing portion 102-2 of the housing 102 than the top housing portion 102-1 of the housing 102). Accordingly, the light beam has space to propagate within the internal portion 124 of the housing 102 (e.g., via one or more other elements of the optical device 100) before entering the output fiber core 110-A, as further described herein.

The first lens 112 may be positioned within the internal portion 124 of the housing 102 (e.g., adjacent to the input fiber 108, such as adjacent to the input fiber core 108-A of the input fiber 108, as shown in FIGS. 1A-1B). The first lens 112 may be configured to receive a light beam (e.g., the light beam 126), such as from the input fiber 108, and to direct the light beam to the spacer 116 (e.g., as further described herein). In this way, the first lens 112 may facilitate propagation of the light beam to the output fiber 110 (e.g., as further described herein). The first lens 112 may comprise glass, plastic, and/or a similar material.

The first lens 112 may include an entrance surface (e.g., through which the light beam enters the first lens 112) and an exit surface (e.g., through which the light exits the first lens 112). In some implementations, both of the entrance surface and the exit surface of the first lens 112 are angled (e.g., arranged at a non-zero angle to a normal of a propagation direction of the light beam to or from the first lens 112) and/or are aspherical, such as to facilitate propagation of the light beam within the internal portion 124 of the housing 102 (e.g., as further described herein). In some implementations, at least one of the entrance surface and the exit surface of the first lens 112 is not angled, such as when the first lens 112 is a gradient-index (GRIN) lens with a non-angled exit surface. Accordingly, in some implementations, both of the entrance surface and the exit surface of the first lens 112 are coated with an optical coating, such as an AR coating (e.g., to further facilitate propagation of the light beam within the internal portion 124 of the housing 102). In some implementations, the input fiber 108 and the first lens 112 may be included together in a subassembly (sometimes referred to as a collimator).

The second lens 114 may be positioned within the internal portion 124 of the housing 102 (e.g., adjacent to the output fiber 110, such as adjacent to the output fiber core 110-A of the output fiber 110, as shown in FIGS. 1A-1B). The second lens 114 may be configured to receive a light beam (e.g., the light beam 126), such as from the spacer 116, and to direct the light beam to the output fiber 110 (e.g., as further described herein). In this way, the second lens 114 may facilitate propagation of the light beam to the output fiber 110 (e.g., as further described herein). The second lens 114 may comprise glass, plastic, and/or a similar material.

The second lens 114 may include an entrance surface (e.g., through which the light beam enters the second lens 114) and an exit surface (e.g., through which the light exits the second lens 114). In some implementations, both of the entrance surface and the exit surface of the second lens 114 are angled (e.g., arranged at a non-zero angle to a normal of a propagation direction of the light beam to or from the second lens 114) and/or are aspherical, such as to facilitate propagation of the light beam to the output fiber 110 (e.g., as further described herein). In some implementations, at least one of the entrance surface and the exit surface of the second lens 114 is not angled, such as when second lens 114 is a GRIN lens with a non-angled entrance surface. Accordingly, in some implementations, both of the entrance surface and the exit surface of the second lens 114 are coated with an optical coating, such as an AR coating (e.g., to further facilitate propagation of the light beam to the output fiber 110). In some implementations, the output fiber 110 and the second lens 114 may be included together in a subassembly (sometimes referred to as a collimator).

The spacer 116 may be positioned within the internal portion 124 of the housing 102 (e.g., between the first lens 112 and the second lens 114, as shown in FIGS. 1A-1B). The spacer 116 may be configured to propagate a light beam (e.g., light beam 126) within the spacer 116 (e.g., as further described herein). In this way, the spacer 116 may facilitate propagation of the light beam to the output fiber 110 (e.g., as further described herein). The spacer 116 may comprise glass, plastic, and/or a similar material.

The spacer 116 may include a first surface (e.g., a left surface of the spacer 116 that is adjacent to the first lens 112 and/or the second filter component 122, and through which the light beam enters the spacer 116 from the first lens 112 and/or is redirected by the second filter component 122, as further described herein) and a second surface (e.g., a right surface of the spacer 116 that is adjacent to the second lens 114 and/or the first filter component 120, and through which the light beam is redirected by the first filter component 120 and/or exits the spacer 116 to the second lens 114, as further described herein). In some implementations, the first surface and the second surface of the spacer 116 may be parallel to each other (or parallel to each other within a tolerance, which may be less than or equal to 0.03 (or 100 sec) degree). In some implementations, at least one of the first surface or the second surface of the spacer 116 is coated with an optical coating, such as an AR coating (e.g., to facilitate propagation of the light beam in to, within, and out of the spacer 116).

The one or more positioning components 118 may be positioned within the internal portion 124 of the housing 102. The one or more positioning components 118 may be configured to position the first lens 112, the second lens 114, and/or the spacer 116 within the internal portion 124 of the housing 102 (e.g., as described herein). For example, as shown in FIGS. 1A-1B, the spacer 116 may be disposed between a first positioning component 118-1 and a second positioning component 118-2 (e.g., in a vertical, stacked configuration) such that the spacer 116 is positioned within a central area of the internal portion 124 of the housing 102. In some implementations, the first positioning component 118-1 and the second positioning component 118-2 may be portions of a same positioning component 118 (e.g., a cylindrical positioning component 118 with a hollow center). Further, the first lens 112 may be disposed between a third positioning component 118-3 and a fourth positioning component 118-4 (e.g., in a vertical, stacked configuration) such that the first lens 112 is positioned adjacent to the input fiber 108 (e.g., adjacent to the input fiber core 108-A of the input fiber 108). In some implementations, the third positioning component 118-3 and the fourth positioning component 118-4 may be portions of a same positioning component 118 (e.g., a cylindrical positioning component 118 with a hollow center). The second lens 114 may be disposed between a fifth positioning component 118-5 and a sixth positioning component 118-6 (e.g., in a vertical, stacked configuration) such that the second lens 114 is positioned adjacent to the output fiber 110 (e.g., adjacent to the output fiber core 110-A of the output fiber 110). In some implementations, the fifth positioning component 118-5 and the sixth positioning component 118-6 may be portions of a same positioning component 118 (e.g., a cylindrical positioning component 118 with a hollow center). In this way, the positioning components 118 may facilitate propagation of a light beam (e.g., light beam 126) from the input fiber 108 to the output fiber 110 (e.g., as further described herein). Each of the one or more positioning components 118 may comprise, for example, glass, ceramic, metal, or a similar material.

The first filter component 120 and the second filter component 122 may each be positioned within the internal portion 124 of the housing 102. As shown in FIGS. 1A-1B, the first filter component 120 may be disposed on the second surface of the spacer 116 (e.g., the right side of the spacer 116). For example, the first filter component 120 may include a first surface (e.g., a left surface of the first filter component 120) and a second surface (e.g., a right surface of the first filter component 120), and the first surface may be disposed on the second surface of the spacer 116. The first filter component 120 may be attached to the spacer 116. For example, an attachment material, such as epoxy, may attach the first surface of the first filter component 120 to the second surface of the spacer 116. A region where light propagates (e.g., light beam 126, described herein) between the first surface of the first filter component 120 and the second surface of the spacer 116 may not include the attachment material (e.g., to avoid damage to the attachment material by the light).

As further shown in FIGS. 1A-1B, the second filter component 122 may be disposed on the first surface of the spacer 116 (e.g., the left side of the spacer 116). For example, the second filter component 122 may include a first surface (e.g., a left surface of the second filter component 122) and a second surface (e.g., a right surface of the second filter component 122), and the second surface may be disposed on the first surface of the spacer 116. The second filter component 122 may be attached to the spacer 116. For example, an attachment material, such as epoxy, may attach the second surface of the second filter component 122 to the first surface of the spacer 116. A region where light propagates (e.g., light beam 126, described herein) between the second surface of the second filter component 122 and the first surface of the spacer 116 may not include the attachment material (e.g., to avoid damage to the attachment material by the light).

Each of the first filter component 120 and the second filter component 122 may comprise glass, ceramic, and/or a similar material. In some implementations, a particular surface of each of the first filter component 120 and the second filter component 122 is coated with an optical coating, such as an optical filter coating (e.g., an optical thin film filter coating). Accordingly, the particular surface may be configured to “pass” one or more particular wavelength ranges of light and to “block” one or more other wavelength ranges of light. Additionally, or alternatively, another surface of each of the first filter component 120 and the second filter component 122 (e.g., that is not the particular surface) is coated with an optical coating, such as an AR coating, which may facilitate passing of the one or more particular wavelength ranges of light (e.g., to minimize power loss associated with the one or more particular wavelength ranges of light).

For example, the first surface of the first filter component 120 may be coated with a first optical filter coating and the second surface of the first filter component 120 may be coated with a first AR coating, or vice versa. As another example, the first surface of the second filter component 122 may be coated with a second optical filter coating and the second surface of the second filter component 122 may be coated with a second AR coating, or vice versa.

In some implementations, the first optical filter coating may be configured to pass a first set of one or more wavelength ranges of light and the second optical filter coating may be configured to pass a second set of one or more wavelength ranges of light. The first set of one or more wavelength ranges of light and the second set of one or more wavelength ranges of light may be partially coextensive. For example, the first set of one or more wavelength ranges of light and the second set of one or more wavelength ranges of light may each include a communal subset of one or more wavelength ranges of light, and the first set of one or more wavelength ranges of light may include a first subset of one or more wavelength ranges of light that are not included in the second set of one or more wavelength ranges of light.

Accordingly, the first AR coating may be configured to facilitate passing of the communal subset of one or more wavelength ranges of light and/or the first subset of one or more wavelength ranges of light. Additionally, or alternatively, the second AR coating may be configured to facilitate passing of the communal subset of one or more wavelength ranges of light and/or blocking one or more other wavelength ranges of light (e.g., that may include the first subset of one or more wavelength ranges of light).

In some implementations, a light beam 126 may emit from another optical device (not shown in FIGS. 1A-1B) and may propagate to the optical device 100 via the input fiber 108 (e.g., may propagate via the input fiber core 108-A of the input fiber 108). As shown in FIG. 1B, the input fiber 108 (e.g., via the input fiber core 108-A) may be configured to emit the light beam 126 to the first lens 112.

As further shown in FIG. 1B, the first lens 112 may be configured to receive the light beam 126 and to direct the light beam 126 to a first region 128 of the first surface of the spacer 116 (e.g., the left surface of the spacer 116). Accordingly, the light beam 126 may fall incident on the first region 128 of the first surface of the spacer 116. In some implementations, the light beam 126 may impinge on the first region 128 of the first surface of the spacer 116 at a non-zero incidence angle (e.g., a non-zero angle to a normal of the first region 128 of the first surface of the spacer 116), such as a non-zero incidence angle with a small value (e.g., less than or equal to four degrees), or another range that includes a maximum upper bound that is less than or equal to four degrees, such as a range between two degrees and three degrees (e.g., greater than or equal to two and less than or equal to three degrees).

As further shown in FIG. 1B, the spacer 116 may be configured to propagate the light beam 126 within the spacer 116 (e.g., at a first propagation angle within the spacer 116) from the first region 128 of the first surface of the spacer 116 to a second region 130 of the second surface of the spacer 116 (e.g., the right surface of the spacer 116) associated with the first filter component 120. Accordingly, the first filter component 120 may receive the light beam 126 (e.g., at the second region 130 of the second surface of the spacer 116).

The first filter component 120 may be configured to filter the light beam 126 (e.g., to create a once-filtered light beam 126-1). For example, a particular surface of the first filter component 120 (e.g., the first surface or the second surface of the first filter component 120) may include the first optical filter coating (e.g., described herein) that is configured to pass a first set of one or more wavelength ranges of light. Accordingly, the first filter component 120 may be configured to pass (e.g., via the particular surface) one or more portions of the light beam 126 that are associated with the first set of one or more wavelength ranges of light and therefore may direct (e.g., via reflection) the one or more portions of the light beam 126 (e.g., the once-filtered light beam 126-1) into the spacer 116 (e.g., via the second region 130 of the second surface of the spacer 116).

Additionally, or alternatively, the first filter component 120 may be configured to block (e.g., via the particular surface) one or more other portions of the light beam 126 that are not associated with the first set of one or more wavelength ranges of light. As shown in FIG. 1B, the one or more other portions of the light beam 126 may propagate through the first filter component 120 to a first blocking region 132 of the one or more positioning components 118. The first blocking region 132 may be configured to absorb the one or more other portions of the light beam 126. Additionally, or alternatively, the first blocking region 132 may have an angled surface (e.g., at a non-zero angle to a normal of a propagation direction of the one or more other portions of the light beam 126), such as to prevent the one or more other portions of the light beam 126 from propagating to the input fiber 108 and/or the output fiber 110.

As further shown in FIG. 1B, the spacer 116 may be configured to propagate the one or more portions of the light beam 126 (herein after referred to as the once-filtered light beam 126-1) within the spacer 116 (e.g., at a second propagation angle within the spacer 116) from the second region 130 of the second surface of the spacer 116 to a third region 134 of the first surface of the spacer 116. Accordingly, the second filter component 122 may receive the once-filtered light beam 126-1 (e.g., at the third region 134 of the first surface of the spacer 116).

The second filter component 122 may be configured to filter the once-filtered light beam 126-1 (e.g., to create a twice-filtered light beam 126-2). For example, a particular surface of the second filter component 122 (e.g., the first surface or the second surface of the second filter component 122) may include the second optical filter coating (e.g., described herein) that is configured to pass a second set of one or more wavelength ranges of light. Accordingly, the second filter component 122 may be configured to pass (e.g., via the particular surface) one or more portions of the once-filtered light beam 126-1 (e.g., one or more subportions of the one or more portions of the light beam 126) that are associated with the second set of one or more wavelength ranges of light, and therefore may direct (e.g., via reflection) the one or more portions of the once-filtered light beam 126-1 into the spacer 116 (e.g., via the third region 134 of the first surface of the spacer 116).

Additionally, or alternatively, the second filter component 122 may be configured to block (e.g., via the particular surface) one or more other portions of the once-filtered light beam 126-1 (e.g., one or more other subportions of the one or more portions of the light beam 126) that are not associated with the second set of one or more wavelength ranges of light. As shown in FIG. 1B, the one or more other portions of the once-filtered light beam 126-1 may propagate through the second filter component 122 to a second blocking region 136 of the one or more positioning components 118. The second blocking region 136 may be configured to absorb the one or more other portions of the once-filtered light beam 126-1. Additionally, or alternatively, the second blocking region 136 may have an angled surface (e.g., at a non-zero angle to a normal of a propagation direction of the one or more other portions of the once-filtered light beam 126-1), such as to prevent the one or more other portions of the once-filtered light beam 126-1 from propagating to the input fiber 108 and/or the output fiber 110.

As further shown in FIG. 1B, the spacer 116 may be configured to propagate the one or more portions of the light beam 126-1 (herein after referred to as the twice-filtered light beam 126-2) within the spacer 116 (e.g., at a third propagation angle within the spacer 116) from the third region 134 of the first surface of the spacer 116 to a fourth region 138 of the second surface of the spacer 116.

Accordingly, the second lens 114 may be configured to receive the twice-filtered light beam 126-2 and to direct the twice-filtered light beam 126-2 to the output fiber 110. For example, as shown in FIG. 1B, the second lens 114 may direct the twice-filtered light beam 126-2 to the output fiber core 110-A of the output fiber 110. The output fiber 110 (e.g., via the output fiber core 110-A) may be configured to propagate the twice-filtered light beam 126-2 from the internal portion 124 of the housing 102 (e.g., to a light beam destination, not shown in FIGS. 1A-1B).

In this way, one or more portions of the light beam 126 (e.g., that are associated with a set of one or more wavelength ranges of light) are propagated to the output fiber 110, and one or more other portions of the light beam 126 (e.g., that are associated with another set of one or more wavelength ranges of light) are prevented from propagating to the output fiber 110 (and to the input fiber 108). In some implementations, a wavelength range gap, which is associated with the one or more portions of the light beam 126 and the one or more other portions of the light beam 126, may satisfy a wavelength range gap threshold. For example, a wavelength range gap between the set of one or more wavelength ranges of light and the other set of one or more wavelength ranges of light (e.g., a difference between a maximum wavelength of a set that has lesser wavelength ranges and a minimum of a set that has greater wavelength ranges) may satisfy (e.g., be less than or equal to) a wavelength range gap threshold. In some implementations, the wavelength range gap threshold may be less than or equal to 0.5 nm, 1 nm, 1.5 nm, or 2 nm, for example. In some implementations, the wavelength range gap threshold may be a percentage of a width of the set of one or more wavelength ranges of light (e.g., a percentage of a difference between a maximum wavelength of the set of one or more wavelength ranges of light and a minimum wavelength of the set of one or more wavelength ranges of light), which may be less than or equal to 1%, 2%, 3%, 4%, or 5%, for example.

As indicated above, FIGS. 1A-1B are provided as an example. Other examples may differ from what is described with regard to FIGS. 1A-1B.

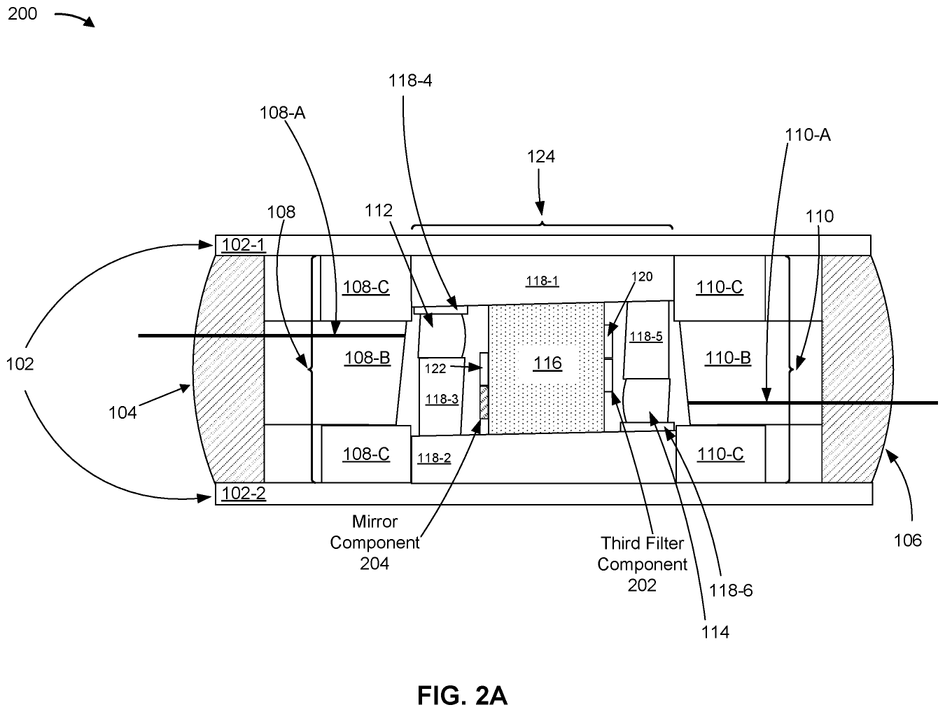

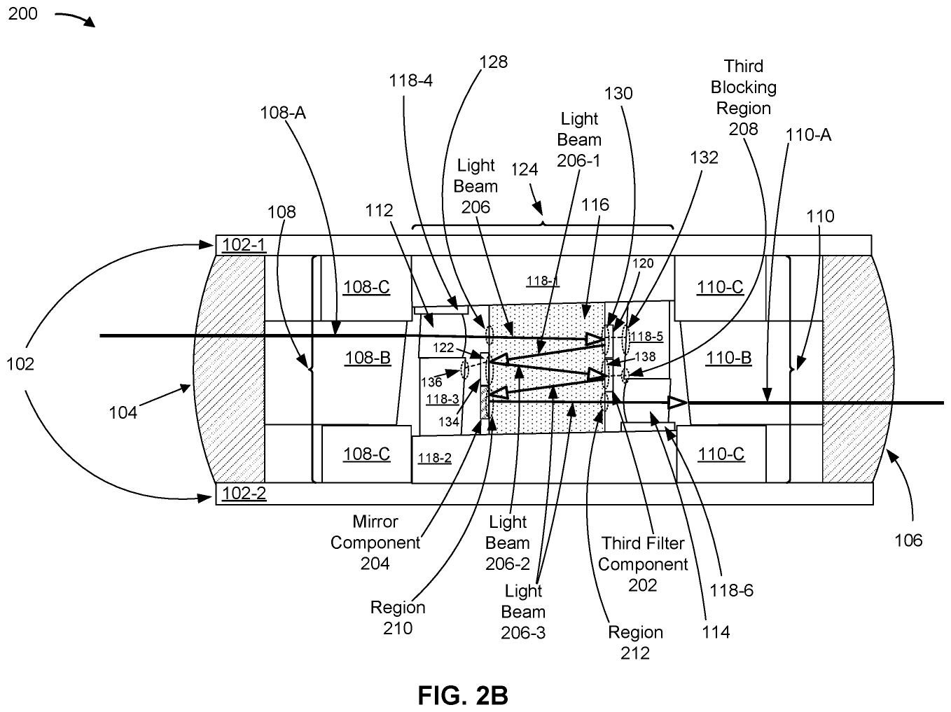

FIGS. 2A-2B are diagrams of an example optical device 200 described herein, such as a wavelength division multiplexing (WDM) device. As shown in FIGS. 2A-2B, the optical device 200 may include the housing 102 (e.g., shown as comprising the top housing portion 102-1 and the bottom housing portion 102-2), the first sealant structure 104, the second sealant structure 106, the input fiber 108, the output fiber 110, the first lens 112, the second lens 114, the spacer 116, the one or more positioning components 118 (e.g., shown as comprising the one or more positioning components 118-1 through 118-6), the first filter component 120, and/or the second filter component 122. As further shown in FIGS. 2A-2B, the optical device 200 may include a third filter component 202 and/or a mirror component 204.

The housing 102, the first sealant structure 104, the second sealant structure 106, the input fiber 108, the output fiber 110, the first lens 112, the second lens 114, the spacer 116, and/or the one or more positioning components 118 may be configured, or positioned, in a same or similar manner as that described herein in relation to FIGS. 1A-1B. The first filter component 120, the second filter component 122, the third filter component 202, and the mirror component 204 may each be positioned within the internal portion 124 of the housing 102 and may be configured and positioned as further described herein.

As shown in FIGS. 2A-2B, the first filter component 120 may be disposed on the second surface of the spacer 116 (e.g., the right side of the spacer 116). For example, the first filter component 120 may include a first surface (e.g., a left surface of the first filter component 120) and a second surface (e.g., a right surface of the first filter component 120), and the first surface may be disposed on the second surface of the spacer 116. The first filter component 120 may be attached to the spacer 116. For example, an attachment material, such as epoxy, may attach the first surface of the first filter component 120 to the second surface of the spacer 116. A region where light propagates (e.g., light beam 206, described herein) between the first surface of the first filter component 120 and the second surface of the spacer 116 may not include the attachment material (e.g., to avoid damage to the attachment material by the light).

As further shown in FIGS. 2A-2B, the second filter component 122 may be disposed on the first surface of the spacer 116 (e.g., the left side of the spacer 116). For example, the second filter component 122 may include a first surface (e.g., a left surface of the second filter component 122) and a second surface (e.g., a right surface of the second filter component 122), and the second surface may be disposed on the first surface of the spacer 116. The second filter component 122 may be attached to the spacer 116. For example, an attachment material, such as epoxy, may attach the second surface of the second filter component 122 to the first surface of the spacer 116. A region where light propagates (e.g., light beam 206, described herein) between the second surface of the second filter component 122 and the first surface of the spacer 116 may not include the attachment material (e.g., to avoid damage to the attachment material by the light).

As further shown in FIGS. 2A-2B, the third filter component 202 may be disposed on the second surface of the spacer 116 (e.g., the right side of the spacer 116). For example, the third filter component 202 may include a first surface (e.g., a left surface of the third filter component 202) and a second surface (e.g., a right surface of the third filter component 202), and the first surface may be disposed on the second surface of the spacer 116. The third filter component 202 may be attached to the spacer 116. For example, an attachment material, such as epoxy, may attach the first surface of the third filter component 202 to the second surface of the spacer 116. A region where light propagates (e.g., light beam 206, described herein) between the first surface of the third filter component 202 and the second surface of the spacer 116 may not include the attachment material (e.g., to avoid damage to the attachment material by the light). As further shown in FIGS. 2A-2B, the first filter component 120 and the third filter component 202 may be disposed on respective regions of the second surface of the spacer 116, such that the first filter component 120 and the third filter component 202 are aligned (e.g., in a vertical formation) on the second surface of the spacer 116.

As further shown in FIGS. 2A-2B, the mirror component 204 may be disposed on the first surface of the spacer 116 (e.g., the left side of the spacer 116). For example, the mirror component 204 may include a first surface (e.g., a left surface of the mirror component 204) and a second surface (e.g., a right surface of the mirror component 204), and the second surface may be disposed on the first surface of the spacer 116. The mirror component 204 may be attached to the spacer 116. For example, an attachment material, such as epoxy, may attach the second surface of the mirror component 204 to the first surface of the spacer 116. A region where light propagates (e.g., light beam 206, described herein) between the second surface of the mirror component 204 to the first surface of the spacer 116 may not include the attachment material (e.g., to avoid damage to the attachment material by the light). As further shown in FIGS. 2A-2B, the second filter component 122 and the mirror component 204 may be disposed on respective regions of the first surface of the spacer 116, such that the second filter component 122 and the mirror component 204 are aligned (e.g., in a vertical formation) on the first surface of the spacer 116.

Each of the first filter component 120, the second filter component 122, and the third filter component 202 may comprise glass, ceramic, and/or a similar material. In some implementations, a particular surface of each of the first filter component 120, the second filter component 122, and the third filter component 202 may be coated with an optical coating, such as an optical filter coating (e.g., an optical thin film filter coating). Accordingly, the particular surface may be configured to pass one or more particular wavelength ranges of light (e.g., reflect the one or more particular wavelength ranges of light that impinge the particular surface) and to block one or more other wavelength ranges of light. Another surface of each of the first filter component 120, the second filter component 122, and the third filter component 202 (e.g., that is not the particular surface) may be coated with an optical coating, such as an AR coating, which may facilitate passing of the one or more particular wavelength ranges of light (e.g., with low loss of light power).

For example, the first surface of the first filter component 120 may be coated with a first optical filter coating and the second surface of the first filter component 120 may be coated with a first AR coating, or vice versa. As another example, the first surface of the second filter component 122 may be coated with a second optical filter coating and the second surface of the second filter component 122 may be coated with a second AR coating, or vice versa. In another example, the first surface of the third filter component 202 may be coated with a second optical filter coating and the second surface of the third filter component 202 may be coated with a second AR coating, or vice versa.

In some implementations, the first optical filter coating may be configured to pass a first set of one or more wavelength ranges of light, the second optical filter coating may be configured to pass a second set of one or more wavelength ranges of light, and the third optical filter coating may be configured to pass a third set of one or more wavelength ranges of light. The first set of one or more wavelength ranges of light, the second set of one or more wavelength ranges of light, and the third set of one or more wavelength ranges of light may be partially coextensive. For example, the first set of one or more wavelength ranges of light, the second set of one or more wavelength ranges of light, and the third set of one or more wavelength ranges of light may each include a communal subset of one or more wavelength ranges of light; the first set of one or more wavelength ranges of light may include a first subset of one or more wavelength ranges of light that are not included in the second set of one or more wavelength ranges of light and the third set of one or more wavelength ranges of light; and the second set of one or more wavelength ranges of light may include a second subset of one or more wavelength ranges of light that are included in the first set of one or more wavelength ranges and that are not included in the third set of one or more wavelength ranges of light.

Accordingly, each of the first AR, the second AR, and/or the third AR coating may be configured to facilitate passing of the communal subset of one or more wavelength ranges of light, the first subset of one or more wavelength ranges of light, and/or the second subset of one or more wavelength ranges of light.

The mirror component 204 may comprise glass, ceramic, and/or a similar material. In some implementations, at least one surface of the mirror component 204 may be coated with an optical coating, such as a reflective coating (e.g., a broadband reflective coating). Accordingly, the at least one surface may be configured to “pass” one or more particular wavelength ranges of light (e.g., reflect the one or more particular wavelength ranges of light that impinge the at least one surface). In some implementations, the mirror component 204 may be configured to pass one or more particular wavelength ranges of light that the third filter component 202 is configured to pass.

In some implementations, a light beam 206 may emit from an optical device (not shown in FIGS. 2A-2B) and may propagate to the optical device 200 via the input fiber 108 (e.g., may propagate via the input fiber core 108-A of the input fiber 108). As shown in FIG. 2B, the input fiber 108 (e.g., via the input fiber core 108-A) may be configured to emit the light beam 206 to the first lens 112.

As further shown in FIG. 2B, the first lens 112 may be configured to receive the light beam 206 and to direct the light beam 206 to a first region 128 of the first surface of the spacer 116 (e.g., the left surface of the spacer 116). Accordingly, the light beam 206 may fall incident on the first region 128 of the first surface of the spacer 116. In some implementations, the light beam 206 may impinge on the first region 128 of the first surface of the spacer 116 at a non-zero incidence angle (e.g., a non-zero angle to a normal of the first region 128 of the first surface of the spacer 116), such as a non-zero incidence angle with a small value (e.g., less than or equal to four degrees), or another range that includes a maximum upper bound that is less than or equal to four degrees.

As further shown in FIG. 2B, the spacer 116 may be configured to propagate the light beam 206 within the spacer 116 (e.g., at a first propagation angle within the spacer 116) from the first region 128 of the first surface of the spacer 116 to a second region 130 of the second surface of the spacer 116 (e.g., the right surface of the spacer 116) associated with the first filter component 120. Accordingly, the first filter component 120 may receive the light beam 206 (e.g., at the second region 130 of the second surface of the spacer 116).

The first filter component 120 may be configured to filter the light beam 206 (e.g., to create a once-filtered light beam 206-1). For example, a particular surface of the first filter component 120 (e.g., the first surface or the second surface of the first filter component 120) may include the first optical filter coating (e.g., described herein) that is configured to pass a first set of one or more wavelength ranges of light. Accordingly, the first filter component 120 may be configured to pass (e.g., via the particular surface) one or more portions of the light beam 206 that are associated with the first set of one or more wavelength ranges of light and therefore may direct (e.g., via reflection) the one or more portions of the light beam 206 (e.g., the once-filtered light beam 206-1) into the spacer 116 (e.g., via the second region 130 of the second surface of the spacer 116).

Additionally, or alternatively, the first filter component 120 may be configured to block (e.g., via the particular surface) one or more other portions of the light beam 206 that are not associated with the first set of one or more wavelength ranges of light. As shown in FIG. 1B, the one or more other portions of the light beam 206 may propagate through the first filter component 120 to a first blocking region 132 of the one or more positioning components 118. The first blocking region 132 may be configured to absorb the one or more other portions of the light beam 206. Additionally, or alternatively, the first blocking region 132 may have an angled surface (e.g., at a non-zero angle to a normal of a propagation direction of the one or more other portions of the light beam 206), such as to prevent the one or more other portions of the light beam 206 from propagating to the input fiber 108 and/or the output fiber 110.

As further shown in FIG. 2B, the spacer 116 may be configured to propagate the one or more portions of the light beam 206 (herein after referred to as the once-filtered light beam 206-1) within the spacer 116 (e.g., at a second propagation angle within the spacer 116) from the second region 130 of the second surface of the spacer 116 to a third region 134 of the first surface of the spacer 116. Accordingly, the second filter component 122 may receive the once-filtered light beam 206-1 (e.g., at the third region 134 of the first surface of the spacer 116).

The second filter component 122 may be configured to filter the once-filtered light beam 206-1 (e.g., to create a twice-filtered light beam 206-2). For example, a particular surface of the second filter component 122 (e.g., the first surface or the second surface of the second filter component 122) may include the second optical filter coating (e.g., described herein) that is configured to pass a second set of one or more wavelength ranges of light. Accordingly, the second filter component 122 may be configured to pass (e.g., via the particular surface) one or more portions of the once-filtered light beam 206-1 (e.g., one or more subportions of the one or more portions of the light beam 206) that are associated with the second set of one or more wavelength ranges of light and therefore may direct (e.g., via reflection) the one or more portions of the once-filtered light beam 206-1 into the spacer 116 (e.g., via the third region 134 of the first surface of the spacer 116).

Additionally, or alternatively, the second filter component 122 may be configured to block (e.g., via the particular surface) one or more other portions of the once-filtered light beam 206-1 (e.g., one or more other subportions of the one or more portions of the light beam 206) that are not associated with the second set of one or more wavelength ranges of light. As shown in FIG. 2B, the one or more other portions of the once-filtered light beam 206-1 may propagate through the second filter component 122 to a second blocking region 136 of the one or more positioning components 118. The second blocking region 136 may be configured to absorb the one or more other portions of the once-filtered light beam 206-1. Additionally, or alternatively, the second blocking region 136 may have an angled surface (e.g., at a non-zero angle to a normal of a propagation direction of the one or more other portions of the once-filtered light beam 206-1), such as to prevent the one or more other portions of the once-filtered light beam 206-1 from propagating to the input fiber 108 and/or the output fiber 110.

As further shown in FIG. 2B, the spacer 116 may be configured to propagate the one or more portions of the once-filtered light beam 206-1 (herein after referred to as the twice-filtered light beam 206-2) within the spacer 116 (e.g., at a third propagation angle within the spacer 116) from the third region 134 of the first surface of the spacer 116 to a fourth region 138 of the second surface of the spacer 116 (e.g., the right surface of the spacer 116) associated with the third filter component 202. Accordingly, the third filter component 202 may receive the twice-filtered light beam 206-2 (e.g., at the fourth region 138 of the second surface of the spacer 116).

The third filter component 202 may be configured to filter the twice-filtered light beam 206-2 (e.g., to create a thrice-filtered light beam 206-3). For example, a particular surface of the third filter component 202 (e.g., the first surface or the second surface of the third filter component 202) may include the third optical filter coating (e.g., described herein) that is configured to pass a third set of one or more wavelength ranges of light. Accordingly, the third filter component 202 may be configured to pass (e.g., via the particular surface) one or more portions of the twice-filtered light beam 206-2 (e.g., one or more sub-subportions of the one or more subportions of the one or more portions of the light beam 206) that are associated with the third set of one or more wavelength ranges of light, and therefore may direct (e.g., via reflection) the one or more portions of the twice-filtered light beam 206-2 into the spacer 116 (e.g., via the fourth region 138 of the second surface of the spacer 116).

Additionally, or alternatively, the third filter component 202 may be configured to block (e.g., via the particular surface) one or more other portions of the twice-filtered light beam 206-2 (e.g., one or more other sub-subportions of the one or more subportions of the one or more portions of the light beam 206) that are not associated with the third set of one or more wavelength ranges of light. As shown in FIG. 2B, the one or more other portions of the twice-filtered light beam 206-2 may propagate through the third filter component 202 to a third blocking region 208 of the one or more positioning components 118. The third blocking region 208 may be configured to absorb the one or more other portions of the twice-filtered light beam 206-2. Additionally, or alternatively, the third blocking region 208 may have an angled surface (e.g., at a non-zero angle to a normal of a propagation direction of the one or more other portions of the twice-filtered light beam 206-2), such as to prevent the one or more other portions of the twice-filtered light beam 206-2 from propagating to the input fiber 108 and/or the output fiber 110.

As further shown in FIG. 2B, the spacer 116 may be configured to propagate the one or more portions of the twice-filtered light beam 206-2 (herein after referred to as the thrice-filtered light beam 206-3) within the spacer 116 (e.g., at a fourth propagation angle within the spacer 116) from the fourth region 138 of the second surface of the spacer 116 to a fifth region 210 of the first surface of the spacer 116. Accordingly, the mirror component 204 may receive the thrice-filtered light beam 206-3 (e.g., at the fifth region 210 of the first surface of the spacer 116).

The mirror component 204 may be configured to pass the thrice-filtered light beam 206-3. For example, at least one surface of the mirror component 204 may include a reflective coating that is configured to pass a set of one or more wavelength ranges of light that the third filter component 202 is configured to pass. Accordingly, the mirror component 204 may be configured to pass (e.g., via the at least one surface) the thrice-filtered light beam 206-3 (e.g., the one or more sub-subportions of the one or more subportions of the one or more portions of the light beam 126) that are associated with the third set of one or more wavelength ranges of light that are passed by the third filter component 202. The mirror component 204 may direct (e.g., via reflection) the thrice-filtered light beam 206-3 into the spacer 116 (e.g., via the fifth region 210 of the second surface of the spacer 116).

As further shown in FIG. 2B, the spacer 116 may be configured to propagate the thrice-filtered light beam 206-3 within the spacer 116 (e.g., at a fifth propagation angle within the spacer 116) from the fifth region 210 of the first surface of the spacer 116 to a sixth region 212 of the second surface of the spacer 116.

Accordingly, the second lens 114 may be configured to receive the thrice-filtered light beam 206-3 and to direct the thrice-filtered light beam 206-3 to the output fiber 110. For example, as shown in FIG. 2B, the second lens 114 may direct the thrice-filtered light beam 206-3 to the output fiber core 110-A of the output fiber 110. The output fiber 110 (e.g., via the output fiber core 110-A) may be configured to propagate the thrice-filtered light beam 206-3 from the internal portion 124 of the housing 102 (e.g., to a light beam destination, not shown in FIGS. 2A-2B).

In this way, one or more portions of the light beam 206 (e.g., that are associated with a set of one or more wavelength ranges of light) are propagated to the output fiber 110 and one or more other portions of the light beam 206 (e.g., that are associated with another set of one or more wavelength ranges of light) are prevented from propagating to the output fiber 110 (and to the input fiber 108). In some implementations, a wavelength range gap, which is associated with the one or more portions of the light beam 206 and the one or more other portions of the light beam 206, may satisfy a wavelength range gap threshold. For example, a wavelength range gap between the set of one or more wavelength ranges of light and the other set of one or more wavelength ranges of light (e.g., a difference between a maximum wavelength of a set that has lesser wavelength ranges and a minimum of a set that has greater wavelength ranges) may satisfy (e.g., be less than or equal to) a wavelength range gap threshold. In some implementations, the wavelength range gap threshold may be less than or equal to 0.5 nm, 1 nm, 1.5 nm, or 2 nm, for example. In some implementations, the wavelength range gap threshold may be a percentage of a width of the set of one or more wavelength ranges of light (e.g., a percentage of a difference between a maximum wavelength of the set of one or more wavelength ranges of light and a minimum wavelength of the set of one or more wavelength ranges of light), which may be less than or equal to 1%, 2%, 3%, 4%, or 5%, for example.

Accordingly, some implementations described herein provide an optical device that includes a plurality of filter components that are configured to propagate a set of one or more wavelength ranges of light to an output fiber of the optical device and to prevent another set of one or more wavelength ranges of light, wherein a wavelength range gap between the set of one or more wavelength ranges of light and the other set of one or more wavelength ranges of light is small (e.g., satisfies a wavelength range gap threshold, as described herein). This is not possible with a single filter optical device due to practical manufacturing limits associated with a single filter optical device. For example, due to coating process limits, a single filter cannot be manufactured to pass all of the set of one or more wavelength ranges and block all of the other set of one or more wavelength ranges (and still fit in an optical device with a footprint that is less than or equal to that of some implementations described herein). Accordingly, some implementations provide an optical performance that cannot be achieved using a single-filter optical device (e.g., within a compact footprint).

As indicated above, FIGS. 2A-2B are provided as an example. Other examples may differ from what is described with regard to FIGS. 2A-2B.

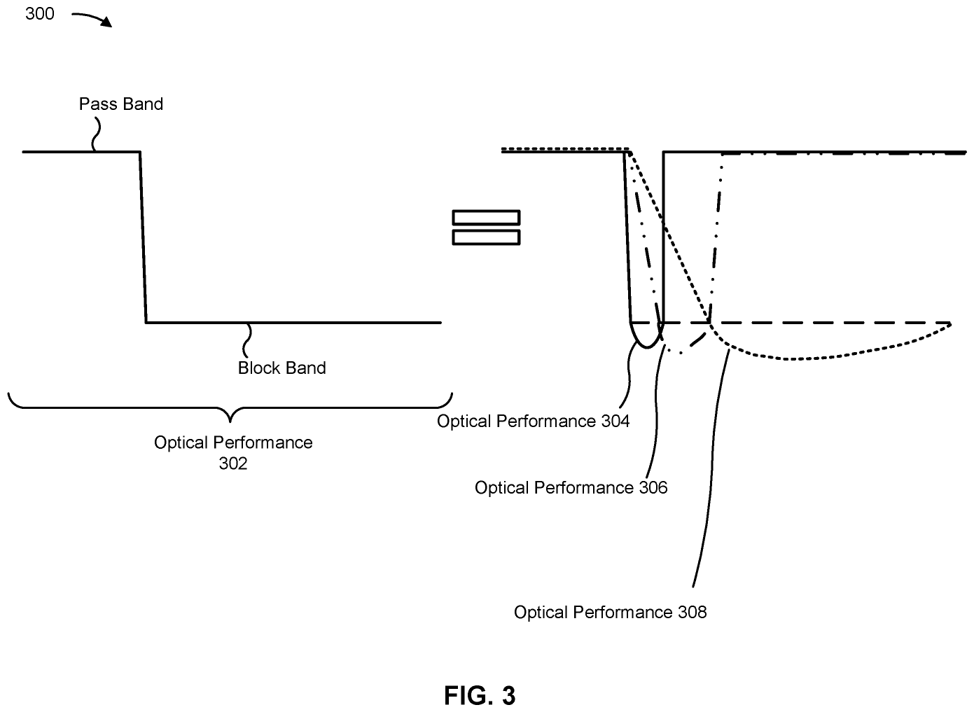

FIG. 3 is a diagram 300 of an example optical performance of an optical device described herein (e.g., optical device 200). As shown in FIG. 3, the optical device may be configured to provide an optical performance 302. The optical performance 302 may include passing one or more portions of a light beam that are associated with a pass band, such as a 1500-1517.5 nm band (e.g., pass a wavelength range of light that is greater than or equal to 1500 nm and less than or equal to 1517.5 nm) and blocking one or more portions of the light beam that are associated with a block band, such as a 1518-1670 nm band (e.g., block a wavelength range of light that is greater than or equal to 1518 nm and less than or equal to 1670 nm).

As further shown in FIG. 3, the optical performance 302 may be achieved based on a first optical performance 304 of a first filter component (e.g., first filter component 120), a second optical performance 306 of a second filter component (e.g., second filter component 122), and a third optical performance 308 of a third filter component (e.g., third filter component 202). As shown by the first optical performance 304, the first filter component may pass one or more first portions of a light beam that are associated with the pass band (e.g., the 1500-1517.5 nm band) and may block one or more second portions of the light beam that are associated with a first portion of the block band, such as a 1518-1520 nm band (e.g., block a wavelength range of light that is greater than or equal to 1518 nm and less than or equal to 1520 nm).). As shown by the second optical performance 306, the second filter component may pass the one or more first portions of the light beam that are associated with the pass band (e.g., the 1500-1517.5 nm band) and may block one or more third portions of the light beam that are associated with a second portion of the block band, such as a 1520-1540 nm band (e.g., block a wavelength range of light that is greater than or equal to 1520 nm and less than or equal to 1540 nm). As shown by the third optical performance 308, the third filter component may pass the one or more first portions of the light beam that are associated with the pass band (e.g., the 1500-1517.5 nm band) and may block one or more fourth portions of the light beam that are associated with a third portion of the block band, such as a 1540-1670 nm band (e.g., block a wavelength range of light that is greater than or equal to 1540 nm and less than or equal to 1670 nm).

In this way, the optical device, based on a combination of respective optical performances of the first filter component, the second filter component, and the third filter component, is configured to pass one or more portions of a light beam that are associated with the pass band and to block one or more portions of the light beam that are associated with the block band. Further, the optical device is able to provide a minimal wavelength range gap between the pass band and the block band (e.g., a difference between a maximum wavelength of light of the pass band and a minimum wavelength of light of the block band is minimized). For example, in relation to the example provided in FIG. 3, the wavelength range gap is 0.5 nm (e.g., a difference between 1517.5 nm and 1518 nm). In some implementations, the wavelength range gap may satisfy a wavelength range gap threshold, which may be less than or equal to 0.5 nm, 1 nm, 1.5 nm, or 2 nm, for example. In some implementations, the wavelength range gap threshold may be a percentage of a width of the pass band (e.g., a percentage of a difference between a maximum wavelength of the pass band and a minimum wavelength of the pass band), which may be less than or equal to 1%, 2%, 3%, 4%, or 5%, for example.

As indicated above, FIG. 3 is provided as an example. Other examples may differ from what is described with regard to FIG. 3.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “bottom,” “above,” “upper,” “top,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A wavelength division multiplexing (WDM) device, comprising:
a housing;
an input fiber;
an output fiber;
a first lens;
a second lens;
a spacer;
a first filter component; and
a second filter component, wherein:
the input fiber is configured to emit a light beam to the first lens;
the first lens is configured to direct the light beam to the spacer;
the spacer is configured to propagate the light beam within the spacer to the first filter component;
the first filter component is configured to pass one or more portions of the light beam to the spacer and to block one or more other portions of the light beam;
the spacer is configured to propagate the one or more portions of the light beam to the second filter component;
the second filter component is configured to pass one or more subportions of the one or more portions of the light beam to the spacer and to block one or more other subportions of the one or more portions of the light beam; and
the spacer is configured to propagate at least some of the one or more subportions of the one or more portions of the light beam to the output fiber.

2. The WDM device of claim 1, wherein:
the one or more subportions of the one or more portions of the light beam are associated with a set of one or more wavelength ranges of light;
the one or more other portions of the light beam and the one or more other subportions of the one or more portions of the light beam are associated with another set of one or more wavelength ranges of light; and
a wavelength range gap between the set of one or more wavelength ranges of light and the other set of one or more wavelength ranges of light satisfies a wavelength range gap threshold.

3. The WDM device of claim 2, wherein the wavelength range gap threshold is less than or equal to 5 percent of a width of the set of one or more wavelength ranges of light.

4. The WDM device of claim 1, wherein the housing is a cylindrical housing and the spacer, the first filter component, and the second filter component are positioned within an internal portion of the housing.

5. The WDM device of claim 1, wherein the input fiber is positioned at a first end of the WDM device and the output fiber is positioned at a second end of the WDM device.

6. The WDM device of claim 5, wherein:
the input fiber includes an input fiber core and an input fiber cladding;
the input fiber core is offset from a central point of the input fiber cladding;
the output fiber includes an output fiber core and an output fiber cladding; and
the output fiber core is offset from a central point of the output fiber cladding.

7. The WDM device of claim 1, wherein the first filter component is disposed on a first surface of the spacer and the second filter component is disposed on a second surface of the spacer,
wherein at least one of the first surface or the second surface is coated with an antireflective coating.

8. The WDM device of claim 1, wherein the light beam, after being directed by the first lens, is configured to impinge on a region of a surface of the spacer at a non-zero incidence angle,
wherein the non-zero incidence angle is between two degrees and three degrees.

9. A wavelength division multiplexing (WDM) device, comprising:
a spacer;
a first filter component; and
a second filter component, wherein:
the spacer is configured to propagate a light beam emitted from an input fiber of the WDM device within the spacer to the first filter component;
the first filter component is configured to filter the light beam to create and direct a once-filtered light beam to the spacer;
the spacer is configured to propagate the once-filtered light beam within the spacer to the second filter component;
the second filter component is configured to filter the once-filtered light beam to create and direct a twice-filtered light beam to the spacer; and
the spacer is configured to propagate the twice-filtered light beam within the spacer to another component of the WDM device.

10. The WDM device of claim 9, wherein propagating the twice-filtered light beam within the spacer to the other component of the WDM device is to propagate one or more portions of the light beam to an output fiber of the WDM device and to prevent one or more other portions of the light beam from propagating to the output fiber.

11. The WDM device of claim 10, wherein:
the one or more portions of the light beam are associated with a set of one or more wavelength ranges of light;
the one or more other portions of the light beam are associated with another set of one or more wavelength ranges of light; and
a wavelength range gap between the set of one or more wavelength ranges of light and the other set of one or more wavelength ranges of light satisfies a wavelength range gap threshold.

12. The WDM device of claim 11, wherein the wavelength range gap threshold is less than or equal to 5 percent of a width of the set of one or more wavelength ranges of light.

13. The WDM device of claim 9, wherein the first filter component is disposed on a first surface of the spacer and the second filter component is disposed on a second surface of the spacer.

14. The WDM device of claim 9, wherein the first filter component includes a first surface and a second surface,
wherein a particular surface, of the first surface or the second surface, is coated with an optical filter coating; or
wherein another particular surface, of the first surface or the second surface, is coated with an antireflective coating.

15. The WDM device of claim 9, wherein the other component of the WDM device is a third filter component, wherein:
the third filter component is configured to filter the twice-filtered light beam to create and direct a thrice-filtered light beam to the spacer;
the spacer is configured to propagate the thrice-filtered light beam within the spacer to a mirror component of the WDM device; and
the mirror component is configured to propagate the thrice-filtered light beam to an output fiber of the WDM device.

16. The WDM device of claim 15, wherein:
the first filter component and the third filter component are disposed on a first surface of the spacer; and
the second filter component and the mirror component are disposed on a second surface of the spacer.

17. A wavelength division multiplexing (WDM) device, comprising:
a cylindrical housing; and
a plurality of filter components disposed within an internal portion of the cylindrical housing, wherein:
a first filter component, of the plurality of filter components, is configured to filter a light beam emitted from an input fiber of the WDM device to create and direct a once-filtered light beam to a second filter component of the plurality of filter components; and
the second filter component is configured to receive and filter the once-filtered light beam to create and direct a twice-filtered light beam to another component of the WDM device.

18. The WDM device of claim 17, wherein the first filter component is disposed on a first surface of a spacer within the internal portion of the cylindrical housing of the WDM device and the second filter component is disposed on a second surface of the spacer, wherein:
the spacer is configured to propagate the once-filtered light beam within the spacer to the second filter component; and
the spacer is configured to propagate the twice-filtered light beam within the spacer to the other component of the WDM device.

19. The WDM device of claim 17, wherein the plurality of filter components are configured to propagate one or more portions of the light beam to an output fiber of the WDM device and to prevent one or more other portions of the light beam from propagating to the output fiber,
wherein a wavelength range gap, which is associated with the one or more portions of the light beam and the one or more other portions of the light beam, satisfies a wavelength range gap threshold.

20. The WDM device of claim 19, wherein the wavelength range gap threshold is less than or equal to 5 percent of a width of one or more wavelength ranges of light associated with the one or more portions of the light beam.

21. The WDM device of claim 17, wherein each filter component, of the plurality of filter components includes, includes a surface that is coated with an optical filter coating.
